(19) United States
(12) Patent Application Publication
(10) Pub. No.: US 2017/0154351 A1
(43) Pub. Date: Jun. 1, 2017

(54) METHOD AND SYSTEM FOR MANAGING REFERRAL REWARDS OF DIGITAL WALLETS

(71) Applicant: MasterCard Asia/Pacific Pte. Ltd., Singapore (SG)

(72) Inventors: Vijin Venugopalan, Singapore (SG); Prashant Sharma, Madison, NJ (US); Joseph Hayes, Montclair, NJ (US)

(21) Appl. No.: 15/351,654

(22) Filed: Nov. 15, 2016

(30) Foreign Application Priority Data
Nov. 27, 2015 (SG) 10201509771U

(51) Int. Cl. G06Q 30/02; G06Q 20/36

(52) U.S. Cl. CPC G06Q 30/0214; G06Q 20/36

(57) ABSTRACT

A method for managing referral rewards of digital wallets is disclosed, the method comprising the steps of receiving at a digital wallet server, a referral-code and registration information for a referral digital wallet, where the registration information includes a first unique identifier and at least one primary account number (PAN) associated with a referral; sending from the digital wallet server, the first unique identifier and the PAN associated with the referral to an issuer server for checking if the first unique identifier exists in an issuer table; receiving at the digital wallet server, confirmation from the issuer server that the first unique identifier does not exist in the issuer table; receiving at the digital wallet server, reward data from the issuer server indicative of a reward; identifying at the digital wallet server, an affiliate digital wallet based on the referral-code; and crediting the affiliate digital wallet with the reward.

### CROSS-REFERENCE TO RELATED APPLICATION

This application is a U.S. National Stage filing under 35 U.S.C. §119, based on and claiming benefit of and priority to SG Patent Application No. 10201509771U filed Nov. 27, 2015.

### TECHNICAL FIELD

The following discloses a method and system for managing referral rewards of digital wallets.

### BACKGROUND

Customer referrals are one of the most effective selling and marketing tools available. By tracking and rewarding customers who recommend their friends to buy a product, use a service, or join a subscription; customers are incentivized to promote the product or service for the merchant or service provider.

The customer referral scheme can be brought into the realm of digital wallets. In that if a customer successfully recommends his friend to acquire a digital wallet, that customer would be rewarded in kind.

However one of the pitfalls in such an implementation is that because a customer can own multiple credit cards issued by a single bank, there is a risk that the existing customer can abuse the system by acquiring a new digital wallet by masquerading as a new customer with another credit card, and claiming the referral. Thereby essentially “referring himself” and reaping the reward unethically.

Thus, there is a want for a customer referral method and system that is capable of addressing the above problem. Furthermore, other desirable features and characteristics will become apparent from the subsequent detailed description and the appended claims, taken in conjunction with the accompanying drawings and this background of the disclosure.

### SUMMARY

According to a first aspect of the invention, a computer-implemented method for managing referral rewards of digital wallets is described, the computer-implemented method comprising the steps of receiving at a digital wallet server, a referral-code and registration information for a referral digital wallet, the registration information including a first unique identifier and at least one primary account number (PAN) associated with a referral; sending from the digital wallet server, the first unique identifier and the at least one PAN associated with the referral to an issuer server for checking if the first unique identifier exists in an issuer table; receiving at the digital wallet server, confirmation from the issuer server that the first unique identifier does not exist in the issuer table; receiving at the digital wallet server, reward data from the issuer server indicative of a reward; identifying at the digital wallet server, an affiliate digital wallet based on the referral-code; and crediting at the digital wallet server, the affiliate digital wallet with the reward.

Preferably, the computer-implemented method further comprises the step of receiving at the digital wallet server, confirmation from the issuer server that the at least one PAN associated with the referral does not exist in the issuer table.

Preferably, the computer-implemented method further comprises the step of creating at the digital wallet server, the referral digital wallet.

Preferably, the computer-implemented method further comprises the step of creating at the digital wallet server, another referral-code, the another referral-code associated with the referral digital wallet.

Preferably, the computer-implemented method further comprises the steps of receiving at the digital wallet server, the another referral-code and registration information for another referral digital wallet, the registration information including a second unique identifier and at least one primary account number (PAN) associated with another referral; sending from the digital wallet server, the second unique identifier and the at least one PAN associated with the another referral to the issuer server for checking if the second unique identifier exists in the issuer table; and receiving at the digital wallet server, an indication from the issuer server that the second unique identifier does exist in the issuer table.

Preferably, the computer-implemented method further comprises the step of creating at the digital wallet server, the another referral digital wallet.

Preferably, the computer-implemented method further comprises the step of creating at the digital wallet server, yet another referral-code, the yet another referral-code associated with the another referral digital wallet.

According to a second aspect of the invention, a system for managing referral rewards of digital wallets is described, the system comprising at least one server configured to receive a referral-code and registration information for a referral digital wallet, the registration information including a first unique identifier and at least one primary account number (PAN) associated with a referral; send the first unique identifier and the at least one PAN associated with the referral to an issuer server for checking if the first unique identifier exists in an issuer table; receive confirmation from the issuer server that the first unique identifier does not exist in the issuer table; receive at the digital wallet server, reward data from the issuer server indicative of a reward; identify at the digital wallet server, an affiliate digital wallet based on the referral-code; and credit at the digital wallet server, the affiliate digital wallet with the reward.

Preferably, the at least one server is further configured to receive confirmation from the issuer server that the at least one PAN associated with the referral does not exist in the issuer table.

Preferably, the at least one server is further configured to create the referral digital wallet.

Preferably, the at least one server is further configured to create another referral-code, the another referral-code associated with the referral digital wallet.

Preferably, the at least one server is further configured to receive the another referral-code and registration information for another referral digital wallet, the registration information including a second unique identifier and at least one primary account number (PAN) associated with another referral; send the second unique identifier and the at least one PAN associated with the another referral to the issuer server for checking if the second unique identifier exists in the issuer table; and receive an indication from the issuer server that the second unique identifier does exist in the issuer table.

Preferably, the at least one server is further configured to create the another referral digital wallet.

Preferably, the at least one server is further configured to create yet another referral-code, the yet another referral-code associated with the another referral digital wallet.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with certain embodiments.

FIG. 1 is a block diagram depicting a system in which an affiliate acquires a digital wallet.

FIG. 2 shows a schematic of an exemplary affiliate device or referral device.

FIG. 3 shows a schematic of an exemplary digital wallet provider server for performing the functions in accordance with an embodiment of the invention.

FIG. 4 depicts an exemplary illustration of an issuer table.

FIG. 5 is a flow chart depicting a method in which an affiliate registers for and acquires an affiliate digital wallet.

FIG. 6 is a block diagram depicting a system in which a referral acquires a referral digital wallet.

FIG. 7 is a flow chart depicting a method in which a referral registers for and acquires a referral digital wallet.

Skilled artisans will appreciate that elements in the figures are illustrated for simplicity and clarity and have not necessarily been depicted to scale. For example, the dimensions of some of the elements in the block diagrams or steps in the flowcharts may be exaggerated with respect to other elements to help improve understanding of the present embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the preferred embodiments to disclose a method and system for managing referral rewards of digital wallets that is able to identify whether a customer who signs up for a new digital wallet is in fact new or unique, and therefore prevent the situation where the customer “refers himself”.

Currently, there exists no mechanism that polices referral of digital wallets in the manner described in the embodiments of the present invention. Therefore, a customer could possibly acquire a new digital wallet by masquerading as a new customer with another credit card, thereby essentially “referring himself” and reaping the reward unethically.

Embodiments of the present invention seek to address the above challenges by providing a method and system for managing referral rewards of digital wallets that is able to identify whether a referring customer is in fact unique, thereby overcoming the identified problem.

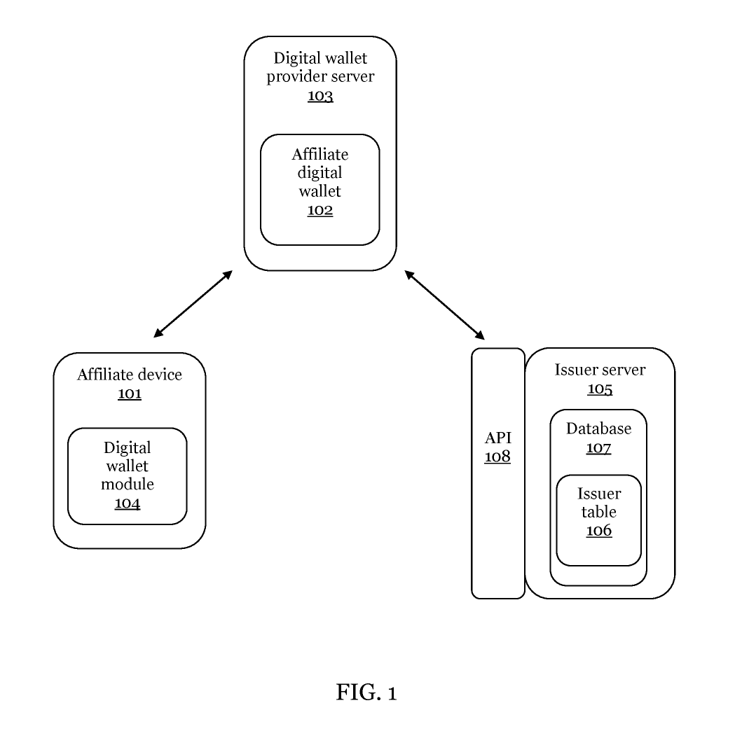

FIG. 1 is a block diagram depicting a system in which a customer or affiliate acquires a digital wallet. In the context of the present embodiments, the affiliate or referrer is the customer who does the referring. An affiliate uses affiliate device 101 to sign up for affiliate digital wallet 102 with digital wallet provider server 103. One example of a digital wallet service implementable via the digital wallet provider server 103 is MasterPass of MasterCard International Incorporated.

Affiliate device 101 may be any electronic device capable of accepting user input relating to payment card credentials and storing digital wallet data relating to at least one digital wallet which acts as a logical container for the payment card credentials. Exemplary affiliate devices 101 include a smart phone, a handheld, a tablet, a laptop computer or a desktop computer or the like. Affiliate device 101 may comprise a digital wallet module 104 which may be in the form of one or more software components comprising program instructions and data for enabling the affiliate device 101 to communicate with the digital wallet provider server 103 in order to create a digital wallet, or add, remove or view payment credentials and other information (e.g. shipping information or loyalty and rewards information) to the digital wallet, and to perform electronic payments and other transactions via the digital wallet provider server 103. In other embodiments, a web browser component on the affiliate device 101 may communicate with the digital wallet provider server 103 (e.g., via an intermediate web server) in order to perform the aforementioned actions.

The system further comprises issuer server 105. Issuer server 105 is managed by an issuer such as a bank (e.g. Citibank) or other financial institution, or a financial services company (e.g. American Express Company). Issuer server 105 comprises or is in communication with a database 107 which stores an issuer table 106. Issuer server 105 sends data to, and receives data from digital wallet provider server 103 via an application programming interface (API) 108.

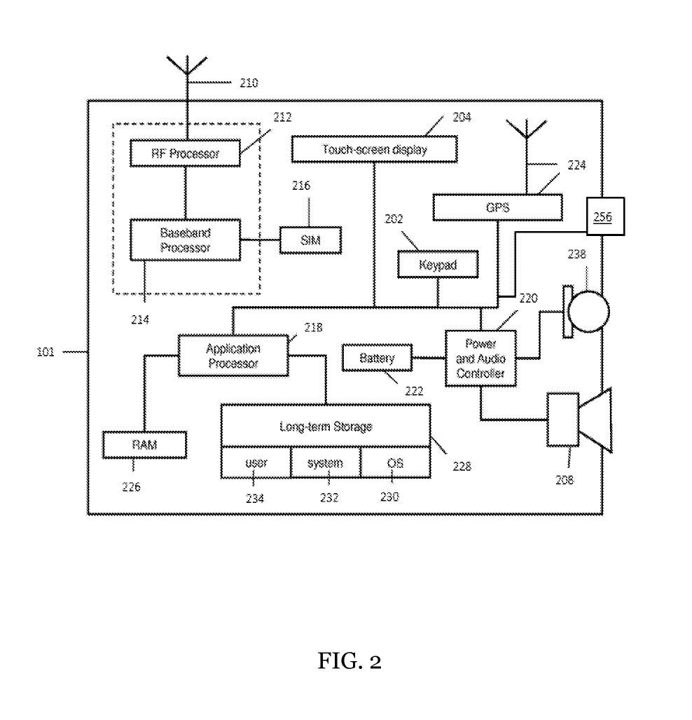

A schematic of an exemplary affiliate device 101 is shown in FIG. 2. Affiliate device 101 comprises keypad 202, touch-screen display 204, microphone 238, speaker 208 and antenna 210. Affiliate device 101 is capable of being operated by a customer to perform a variety of different functions, such as, for example, hosting a telephone call, sending an SMS message, browsing the Internet, sending an email and providing satellite navigation. Affiliate device 101 comprises hardware to perform communication functions (e.g. telephony, data communication), together with an application processor and corresponding support hardware to enable other functions of the wireless device, such as, messaging, Internet browsing, email functions and the like. The communication hardware is represented by RF processor 212 which provides an RF signal to the antenna 210 for the transmission of data signals, and the receipt therefrom. For example, affiliate device 101 can send data to, and receive data from digital wallet provider server 103 via antenna 210. Additionally provided is baseband processor 214, which provides signals to and receives signals from RF Processor 212. Baseband processor 214 also interacts with a subscriber identity module 216, as is well known in the art. The communication subsystem enables affiliate device 101 to communicate via a number of different communication protocols including 3G, 4G, GSM, WiFi, Wi-fi direct, Near Field Communication (NFC), Bluetooth™ and/or CDMA.

Keypad 202 and touch-screen display 204 are controlled by application processor 218. Power and audio controller 220 is provided to supply power from battery 222 to the communication subsystem, application processor 218, and the other hardware. Power and audio controller 220 also controls input from microphone 238, and audio output via speaker 208. Also provided is global positioning system (GPS) antenna and associated receiver element 224 which is controlled by application processor 218 and is capable of receiving a GPS signal for use with a satellite navigation functionality of affiliate device 101.

In order for the application processor 218 to operate, various different types of memory are provided. Firstly, affiliate device 101 includes Random Access Memory (RAM) 226 connected to application processor 218 into which data and program code can be written and read from at will. Code placed anywhere in RAM 226 can be executed by application processor 218 from RAM 226. RAM 226 represents a volatile memory of affiliate device 101. Secondly, affiliate device 101 is provided with long-term storage 228 connected to application processor 218. Long-term storage 228 comprises three partitions, an operating system (OS) partition 230, system partition 232 and user partition 234. Long-term storage 228 represents a non-volatile memory of affiliate device 101.

In the present example, OS partition 230 contains the firmware of affiliate device 101 which includes an operating system. Other computer programs may also be stored on long-term storage 228, such as application programs, and the like. In particular, application programs which are mandatory to affiliate device 101, such as, in the case of a smartphone, communications applications and the like are typically stored in system partition 232. The application programs stored on system partition 232 would typically be those which are bundled with affiliate device 101 by the device manufacturer when affiliate device 101 is first sold. Application programs which are added to affiliate device 101 by the customer would usually be stored in user partition 234. For example, the digital wallet module 104 can be stored in user partition 234. As stated, the representation of FIG. 2 is schematic. In practice, the various functional components illustrated may be substituted into one and the same component. For example, long-term storage 228 may comprise NAND flash, NOR flash, a hard disk drive or a combination of these. Affiliate device 101 may also have an image capturing module 256. Image capturing module 256, together with a suitable application, may be used to capture/scan QR codes and process the data embedded in the QR code.

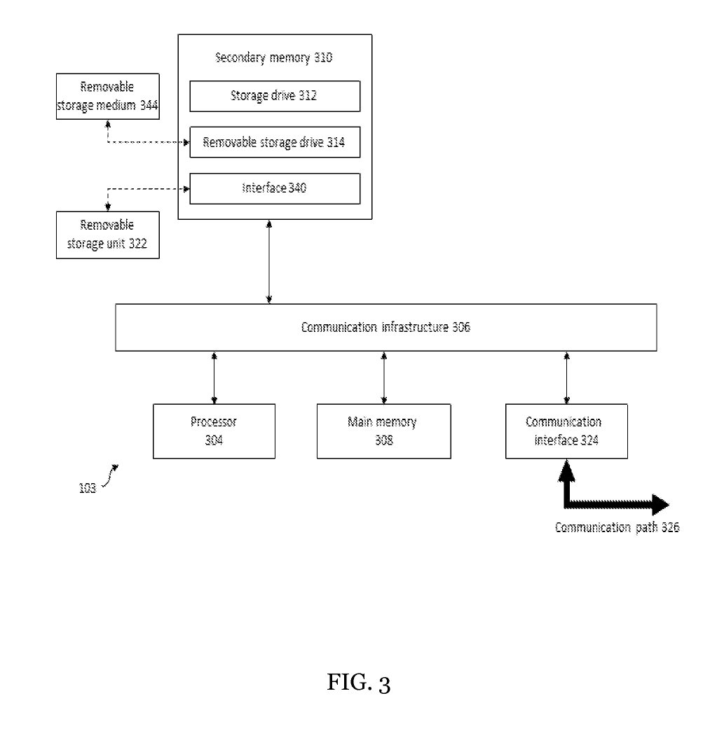

The following description of digital wallet provider server 103 is provided by way of example only and is not intended to be limiting. Digital wallet provider server 103 may comprise of a server or a plurality of servers. As shown in FIG. 3, the exemplary digital wallet provider server 103 includes a processor 304 for executing software routines. Although a single processor is shown for the sake of clarity, digital wallet provider server 103 may also include a multi-processor system. The processor 304 is connected to a communication infrastructure 306 for communication with other components of digital wallet provider server 103. The communication infrastructure 306 may include, for example, a communications bus, cross-bar, or network. Digital wallet provider server 103 further includes a main memory 308, such as a random access memory (RAM), and a secondary memory 310.

The secondary memory 310 may include, for example, a storage drive 312, which may be a hard disk drive, a solid state drive or a hybrid drive and/or a removable storage drive 314, which may include a magnetic tape drive, an optical disk drive, a solid state storage drive (such as a USB flash drive, a flash memory device, a solid state drive or a memory card), or the like. The removable storage drive 314 reads from and/or writes to a removable storage medium 344 in a well-known manner. The removable storage medium 344 may include magnetic tape, optical disk, non-volatile memory storage medium, or the like, which is read by and written to by removable storage drive 314. As will be appreciated by persons skilled in the relevant art(s), the removable storage medium 344 includes a computer readable storage medium having stored therein computer executable program code instructions and/or data. In an alternative implementation, the secondary memory 310 may additionally or alternatively include other similar means for allowing computer programs or other instructions to be loaded into digital wallet provider server 103. Such means can include, for example, a removable storage unit 322. Examples of a removable storage unit 322 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 which allow software and data to be transferred from the removable storage unit 322 to digital wallet provider server 103. Affiliate digital wallet 102 may be stored in either storage drive 312, or removable storage drive 314, or may be accessed remotely by digital wallet provider server 103 via interface 340.

Digital wallet provider server 103 also includes at least one communication interface 324. The communication interface 324 allows software and data to be transferred between digital wallet provider server 103 and external devices via a communication path 326. In various embodiments of the inventions, the communication interface 324 permits data to be transferred between digital wallet provider server 103 and a data communication network, such as a public data or private data communication network. Examples of a communication interface 324 can include a modem, a network interface (such as an Ethernet card), a communication port (such as a serial, parallel, printer, GPIB, IEEE 1394, RJ45, USB), an antenna with associated circuitry and the like. The communication interface 324 may be wired or may be wireless. Software and data transferred via the communication interface 324 are in the form of signals which can be electronic, electromagnetic, optical or other signals capable of being received by communication interface 324. These signals are provided to the communication interface via the communication path 326.

Software may be stored in a computer program product and loaded into digital wallet provider server 103 using the removable storage drive 314, the storage drive 312, or the interface 340. Alternatively, the computer program product may be downloaded to digital wallet provider server 103 over the communications path 326. The software, when executed by the processor 304, causes digital wallet provider server 103 to perform functions of embodiments described herein. It is to be understood that the embodiment of FIG. 3 is presented merely by way of example. Therefore, in some embodiments one or more features of digital wallet provider server 103 may be omitted. Also, in some embodiments, one or more features of digital wallet provider server 103 may be combined together. Additionally, in some embodiments, one or more features of digital wallet provider server 103 may be split into one or more component parts.

As used herein, the term “computer program product” may refer, in part, to removable storage medium 344, removable storage unit 322, a hard disk installed in storage drive 312, or a carrier wave carrying software over communication path 326 (wireless link or cable) to communication interface 324. Computer readable storage media refers to any non-transitory, non-volatile tangible storage medium that provides recorded instructions and/or data to digital wallet provider server 103 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of digital wallet provider server 103. Examples of transitory or non-tangible computer readable transmission media that may also participate in the provision of software, application programs, instructions and/or data to digital wallet provider server 103 include radio or infra-red transmission channels as well as a network connection to another computer or networked device, and the Internet or Intranets including e-mail transmissions and information recorded on Websites and the like.

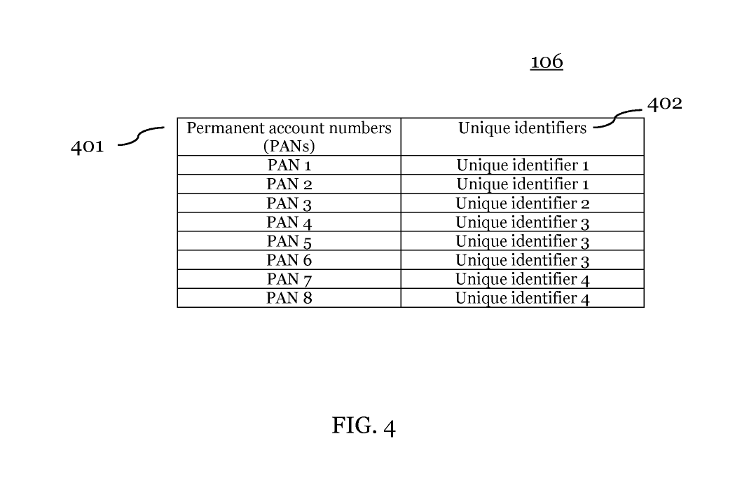

Issuer table 106 contains the list of unique bank customers who have a digital wallet with digital wallet provider server 103. This list of unique customers is represented as a list of unique identifiers in issuer table 106. Each unique customer is represented by a unique identifier. Issuer table 106 also contains the customers' primary account numbers (PANs). An exemplary illustration of issuer table 106 is provided in FIG. 4. Issuer table 106 comprises a plurality of primary account numbers (PANs) 401. PANs 401 can be credit card or debit card numbers, prepaid card numbers, or bank account numbers, for example. A single unique identifier 402 can be associated with a plurality of PANs 401 as a customer can have multiple payment instruments (e.g. credit cards, debit cards and the like) having corresponding numbers registered with the bank.

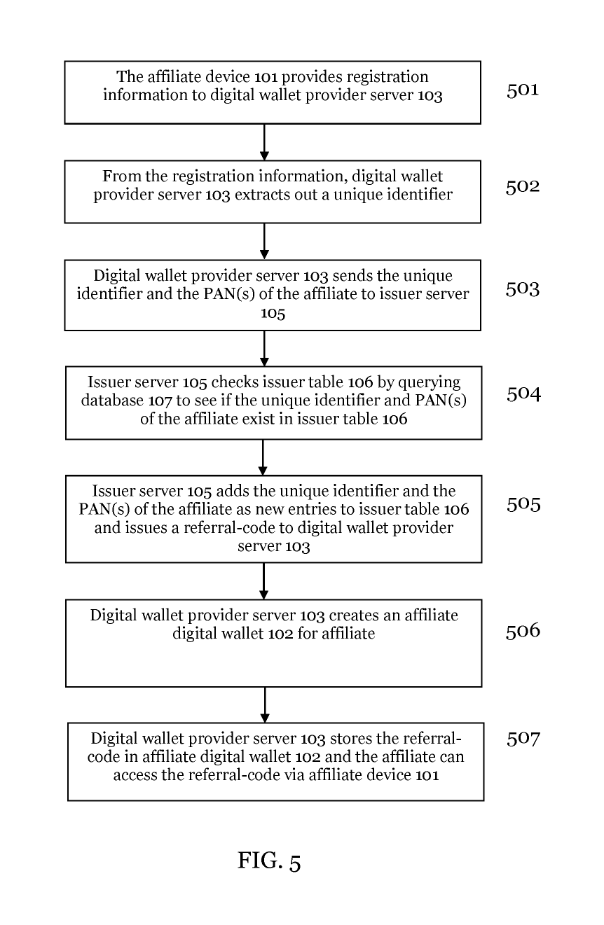

FIG. 5 is a flow chart depicting a method in which an affiliate registers for and acquires an affiliate digital wallet 102.

In step 501, the affiliate device 101 provides registration information, for example via digital wallet module 104 to digital wallet provider server 103. The registration information can include the affiliate's name, identification card number, passport number, postal address, email address, handphone number, and any other personal information relating to the affiliate. The registration information can also include the at least one PANs to which the affiliate wishes to associate affiliate digital wallet 102.

In step 502, from the registration information, digital wallet provider server 103 extracts out a unique identifier. This unique identifier can be the affiliate's email address, the affiliate's handphone number, or the affiliate's identification card number, or any other registration information that can uniquely identify the affiliate. The unique identifier however has to be a key utilized in issuer table 106.

In step 503, digital wallet provider server 103 sends the unique identifier and the PAN(s) of the affiliate to issuer server 105 and a request for the issuer server 105 to check whether the unique identifier already exists, i.e. whether the affiliate already has a digital wallet.

In step 504, issuer server 105 checks issuer table 106 by querying database 107 to see if the unique identifier and PAN(s) of the affiliate exist in issuer table 106. As the affiliate is a new customer, the unique identifier and PAN(s) of affiliate will not exist in issuer table 106.

In step 505, issuer server 105 adds the unique identifier and the PAN(s) of the affiliate as new entries to issuer table 106 and issues a referral-code to digital wallet provider server 103.

In step 506, digital wallet provider server 103 creates an affiliate digital wallet 102 for the affiliate.

In step 507, digital wallet provider server 103 stores the referral-code in affiliate digital wallet 102 and the affiliate can access the referral-code via affiliate device 101. The referral-code is a code that is uniquely tagged to affiliate digital wallet 102. This is so that if the customer referral process is successful, issuer server 105 and digital wallet provider server 103 would be able to identify affiliate digital wallet 102 which will receive the reward.

The affiliate then passes the referral-code to a referral. In the context of this invention, the referral or referee is the customer who is being referred.

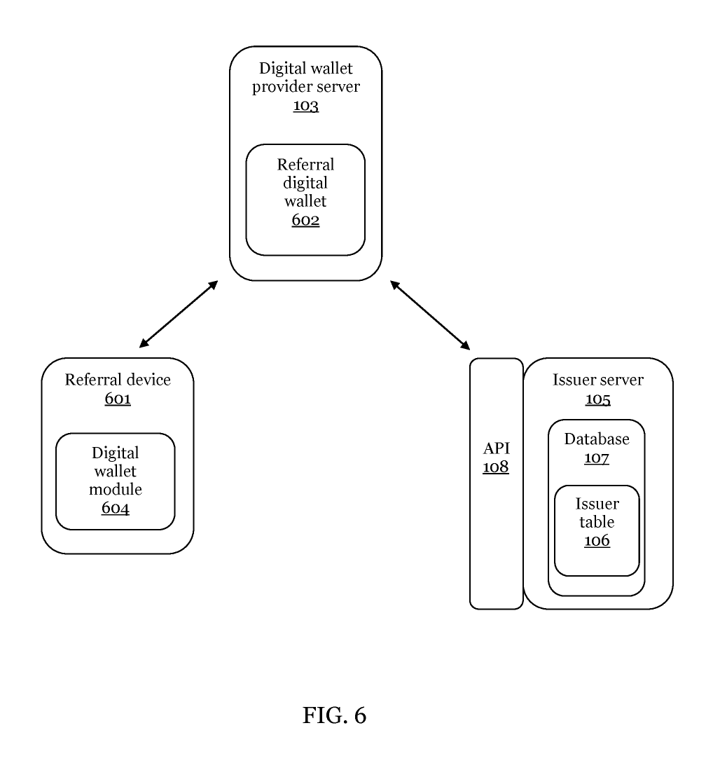

FIG. 6 is a block diagram depicting a system in which the referral acquires a referral digital wallet 602 with digital wallet provider server 103. The referral uses referral device 601 to register for referral digital wallet 602 with digital wallet provider server 103. Referral device 601 can have similar components to affiliate device 101 as described herein. For example, referral device 601 may also comprise digital wallet module 604.

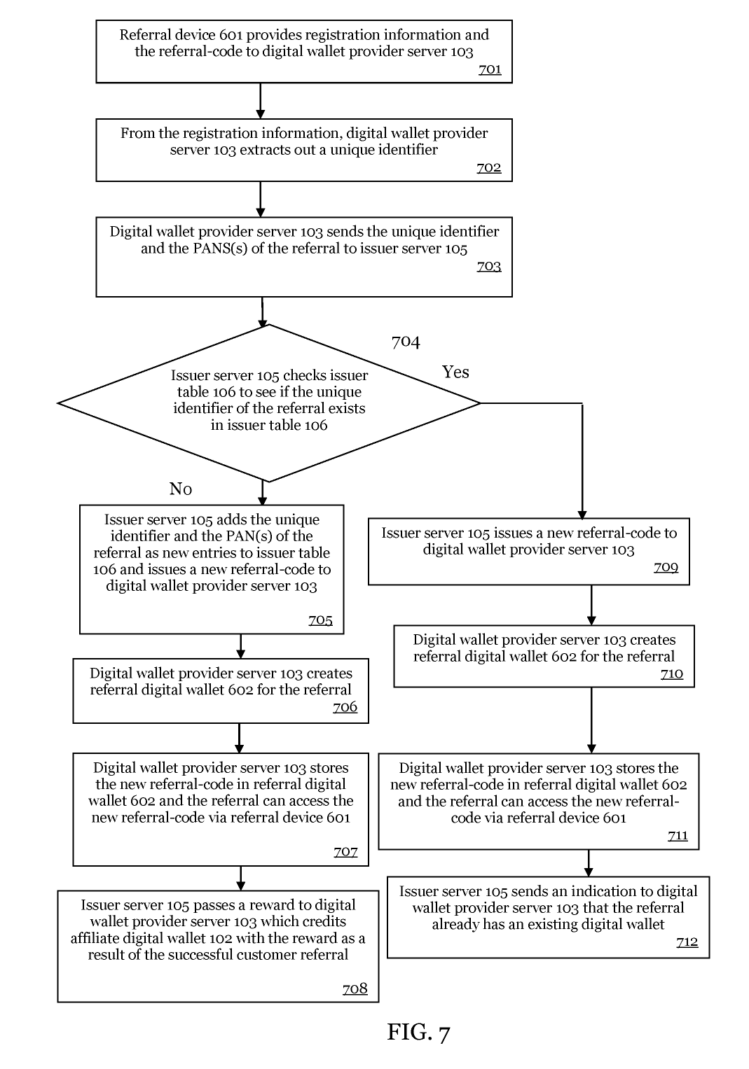

FIG. 7 is a flow chart depicting a method in which the referral registers for and acquires referral digital wallet 602 with digital wallet provider server 103.

In step 701, the referral device 601 provides registration information and the referral-code, for example via digital wallet module 604 to digital wallet provider server 103. The registration information can include the referral's name, identification card number, passport number, postal address, email address, handphone number, and any other personal information relating to the referral. The registration information can also include the at least one PANs to which the referral wishes to associate referral digital wallet 602.

In step 702, from the registration information, digital wallet provider server 103 extracts a unique identifier. This unique identifier can be the referral's email address, the referral's handphone number, or the referral's identification card number, or any other registration information that can uniquely identify the referral. The unique identifier however has to be a key utilized in issuer table 106.

In step 703, digital wallet provider server 103 sends the unique identifier and the PAN(s) of the referral to issuer server 105.

In step 704, issuer server 105 checks issuer table 106 to see if the unique identifier of the referral exists in issuer table 106, for example by using a string matching algorithm. Optionally, the issuer server 105 may also check whether the PAN(s) of the referral exist(s) in the issuer table 106.

If the unique identifier and PAN(s) of the referral do not exist in issuer table 106, in step 705, issuer server 105 adds the unique identifier and the PAN(s) of the referral as new entries to issuer table 106 and issues a new referral-code to digital wallet provider server 103.

In step 706, digital wallet provider server 103 creates referral digital wallet 602 for the referral.

In step 707, digital wallet provider server 103 stores the new referral-code in referral digital wallet 602 and the referral can access the new referral-code via referral device 601. The new referral-code is a code that is uniquely tagged to referral digital wallet 602. This is because the referral now has a chance to refer other referrals, and if his referral process is successful, the issuer server 105 would be able to identify the referral and send the reward accordingly. The referral (now assuming the role of an affiliate) then passes the new referral-code to another referral and the cycle continues.

In step 708, issuer server 105 passes a reward to digital wallet provider server 103 which credits affiliate digital wallet 102 with the reward as a result of the successful customer referral. Digital wallet provider server 103 identifies affiliate digital wallet 102 via the referral-code. The reward may be in the form of reward points which is credited to affiliate digital wallet 102.

If however the unique identifier of the referral exists in issuer table 106, in step 709, issuer server 105 issues a new referral-code to digital wallet provider server 103. Because the issuer table 106 was not updated, issuer server 105 has detected that the referral is not a new customer and may be a case of a customer referring himself to claim the reward unethically. The new referral-code is a code that is uniquely tagged to referral digital wallet 602. Even though it has been determined that in this instance it is probably a case of self-referral, issuer server 105 still issues the new referral-code for the referral. This is because despite the unsuccessful attempt to claim the reward by the self-referral, the referral still has the potential to genuinely refer other customers or referrals. If this does occur, issuer server 105 would then be able to identify the referral via the new referral-code and send the reward accordingly.

In step 710, digital wallet provider server 103 creates referral digital wallet 602 for the referral.

In step 711, digital wallet provider server 103 stores the new referral-code in referral digital wallet 602 and the referral can access the new referral-code via referral device 601.

In step 712, issuer server 105 sends an indication to digital wallet provider server 103 that the referral already has an existing digital wallet i.e. the unique identifier of the referral already exists in issuer table 106. In such an event, issuer server 105 does not pass a reward to digital wallet provider server 103. The invention is therefore capable of sieving out which customers are new or unique, and avoid crediting rewards to customers who refer themselves.

In the application, unless specified otherwise, the terms “comprising”, “comprise”, and grammatical variants thereof, intended to represent “open” or “inclusive” language such that they include recited elements but also permit inclusion of additional, non-explicitly recited elements. The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

1. A computer-implemented method for managing referral rewards of digital wallets comprising the steps of:
receiving at a digital wallet server, a referral-code and registration information for a referral digital wallet, the registration information including a first unique identifier and at least one primary account number (PAN) associated with a referral;
sending from the digital wallet server, the first unique identifier and the at least one PAN associated with the referral to an issuer server for checking if the first unique identifier exists in an issuer table;
receiving at the digital wallet server, confirmation from the issuer server that the first unique identifier does not exist in the issuer table;
receiving at the digital wallet server, reward data from the issuer server indicative of a reward;
identifying at the digital wallet server, an affiliate digital wallet based on the referral-code; and
crediting at the digital wallet server, the affiliate digital wallet with the reward.

2. The method of claim 1 further comprising the step of receiving at the digital wallet server, confirmation from the issuer server that the at least one PAN associated with the referral does not exist in the issuer table.

3. The method of claim 1 further comprising the step of creating at the digital wallet server, the referral digital wallet.

4. The method of claim 3 further comprising the step of creating at the digital wallet server, another referral-code, the another referral-code associated with the referral digital wallet.

5. The method of claim 4 further comprising the steps of:
receiving at the digital wallet server, the another referral-code and registration information for another referral digital wallet, the registration information including a second unique identifier and at least one primary account number (PAN) associated with another referral;
sending from the digital wallet server, the second unique identifier and the at least one PAN associated with the another referral to the issuer server for checking if the second unique identifier exists in the issuer table; and
receiving at the digital wallet server, an indication from the issuer server that the second unique identifier does exist in the issuer table.

6. The method of claim 5 further comprising the step of creating at the digital wallet server, the another referral digital wallet.

7. The method of claim 6 further comprising the step of creating at the digital wallet server, yet another referral-code, the yet another referral-code associated with the another referral digital wallet.

8. A system for managing referral rewards of digital wallets comprising at least one server configured to:
receive a referral-code and registration information for a referral digital wallet, the registration information including a first unique identifier and at least one primary account number (PAN) associated with a referral;
send the first unique identifier and the at least one PAN associated with the referral to an issuer server for checking if the first unique identifier exists in an issuer table;
receive confirmation from the issuer server that the first unique identifier does not exist in the issuer table;
receive at the digital wallet server, reward data from the issuer server indicative of a reward;
identify at the digital wallet server, an affiliate digital wallet based on the referral-code; and
credit at the digital wallet server, the affiliate digital wallet with the reward.

9. The system of claim 8 wherein the at least one server is further configured to receive confirmation from the issuer server that the at least one PAN associated with the referral does not exist in the issuer table.

10. The system of claim 8 wherein the at least one server is further configured to create the referral digital wallet.

11. The system of claim 10 wherein the at least one server is further configured to create another referral-code, the another referral-code associated with the referral digital wallet.

12. The system of claim 11 wherein the at least one server is further configured to:
receive the another referral-code and registration information for another referral digital wallet, the registration information including a second unique identifier and at least one primary account number (PAN) associated with another referral;
send the second unique identifier and the at least one PAN associated with the another referral to the issuer server for checking if the second unique identifier exists in the issuer table; and
receive an indication from the issuer server that the second unique identifier does exist in the issuer table.

13. The system of claim 12 wherein the at least one server is further configured to create the another referral digital wallet.

14. The system of claim 13 wherein the at least one server is further configured to create yet another referral-code, the yet another referral-code associated with the another referral digital wallet.
